(19) United States
(12) Patent Application Publication
(10) Pub. No.: US 2022/0308674 A1
(43) Pub. Date: Sep. 29, 2022

(54) GESTURE-BASED VISUAL EFFECT ON AUGMENTED REALITY OBJECT

(71) Applicant: Lenovo (Singapore) Pte. Ltd., Singapore (SG)

(72) Inventors: John Weldon Nicholson, Cary, NC (US); Daryl C. Cromer, Raleigh, NC (US); Howard Locker, Cary, NC (US); Mengnan Wang, Chapel Hill, NC (US)

(21) Appl. No.: 17/210,069

(22) Filed: Mar. 23, 2021

(51) Int. Cl. G06F 3/01; G02B 27/00; G02B 27/01; G06T 19/20; G06T 19/00

(52) U.S. Cl. CPC G06F 3/017; G06F 3/013; G06F 3/015; G02B 27/0093; G02B 27/0172; G06T 19/20; G06T 19/006; G06T 2219/2016

(57) ABSTRACT

One embodiment provides a method, including: displaying, on a display screen of an augmented reality device, a virtual object; detecting, using at least one sensor associated with the augmented reality device, motion data from a user; determining, using a processor, whether the motion data corresponds to a micro-motion gesture; and enacting, responsive to determining that the motion data corresponds to the micro-motion gesture, a visual effect on the virtual object. Other aspects are described and claimed.

### BACKGROUND

As technology progresses, an increased number of information handling devices (“devices”), for example smart phones, tablet devices, wearable devices such as smart watches and headsets, and the like, have augmented reality capabilities. More particularly, these devices are able to superimpose digital content (e.g., images, sounds, haptic effects, etc.) over real-world scenes. Advances in this space have led to many practical applications of augmented reality in business, recreation, education, healthcare, and many more fields.

### BRIEF SUMMARY

In summary, one aspect provides a method, including: displaying, on a display screen of an augmented reality device, a virtual object; detecting, using at least one sensor associated with the augmented reality device, motion data from a user; determining, using a processor, whether the motion data corresponds to a micro-motion gesture; and enacting, responsive to determining that the motion data corresponds to the micro-motion gesture, a visual effect on the virtual object.

Another aspect provides an information handling device, including: a sensor; a display screen; a processor; a memory device that stores instructions executable by the processor to: display a virtual object; detect motion data from a user; determine whether the motion data corresponds to a micro-motion gesture; and enact, responsive to determining that the motion data corresponds to the micro-motion gesture, a visual effect on the virtual object; wherein the information handling device is an augmented reality device.

A further aspect provides a product, including: a storage device that stores code, the code being executable by a processor and comprising: code that displays a virtual object; code that detects motion data from a user; code that determines whether the motion data corresponds to a micro-motion gesture; and code that enacts, responsive to determining that the motion data corresponds to the micro-motion gesture, a visual effect on the virtual object.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example method of enacting a visual effect on a virtual object displayed on an augmented reality device.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

A user may view and interact with a variety of different types of augmented reality (“AR”) objects on their device. Situations may arise where the user would like to examine a particular object in greater visual detail. For example, a plurality of virtual application windows may be presented on a user's AR display (e.g., a social media application, an email application, an internet browser, etc.). In order to better visualize the content within a particular application window, a user may desire to obtain an enlarged view of the content.

Conventionally, a user could magnify, or zoom in on, a virtual AR object by utilizing a hand gesture or touch control. Although generally effective, such a requirement may be burdensome, or even impossible, in certain contexts or for certain individuals. For example, a user may find themselves in a situation where their hands are preoccupied (e.g., they are holding an object, their hands are involved in the performance of another task, etc.). Additionally or alternatively, other individuals may have various handicaps that prevent them from raising their hand or arm above a certain height threshold, from making a required gesture, or from performing a certain touch sequence.

Accordingly, an embodiment provides a method for enacting a visual effect on a virtual object in response to detecting a natural and intuitive user gesture. In an embodiment, at least one virtual object may be presented on a display of an augmented reality device. The virtual object may be an augmented reality object positioned in a point in space. When sensors associated with the augmented reality device detect user movement, an embodiment may determine whether that detected motion was simply conventional user movement or, alternatively, was intended to be a user command to facilitate some type of visual effect associated with the virtual object. Responsive to determining it was the latter, an embodiment may enact a visual effect on the virtual object (e.g., magnify or reduce the virtual object, center the virtual object on the display, etc.). Such a method may provide enable users to control their augmented reality system in a more natural and intuitive way.

The illustrated example embodiments will be best understood by reference to the figures. The following description is intended only by way of example, and simply illustrates certain example embodiments.

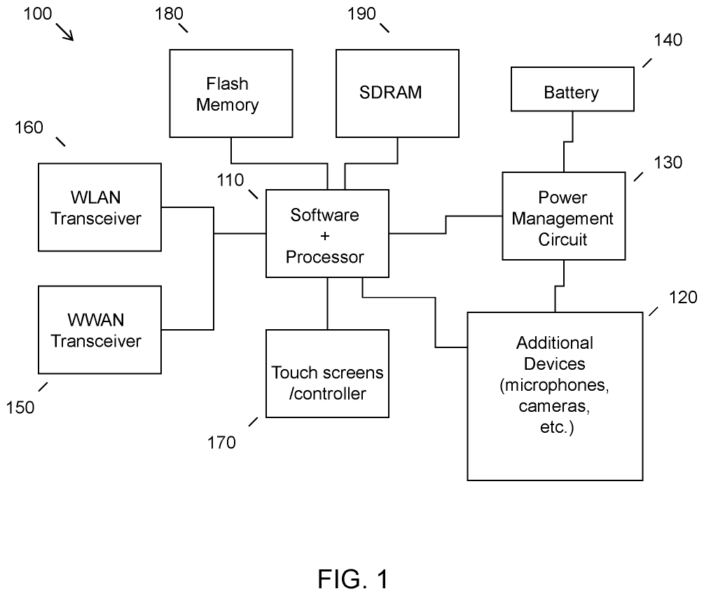

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, I/O ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use SATA or PCI or LPC. Common interfaces, for example, include SDIO and I2C.

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply BIOS like functionality and DRAM memory.

System 100 typically includes one or more of a WWAN transceiver 150 and a WLAN transceiver 160 for connecting to various networks, such as telecommunications networks and wireless Internet devices, e.g., access points. Additionally, devices 120 are commonly included, e.g., an image sensor such as a camera, audio capture device such as a microphone, etc. System 100 often includes one or more touch screens 170 for data input and display/rendering. System 100 also typically includes various memory devices, for example flash memory 180 and SDRAM 190.

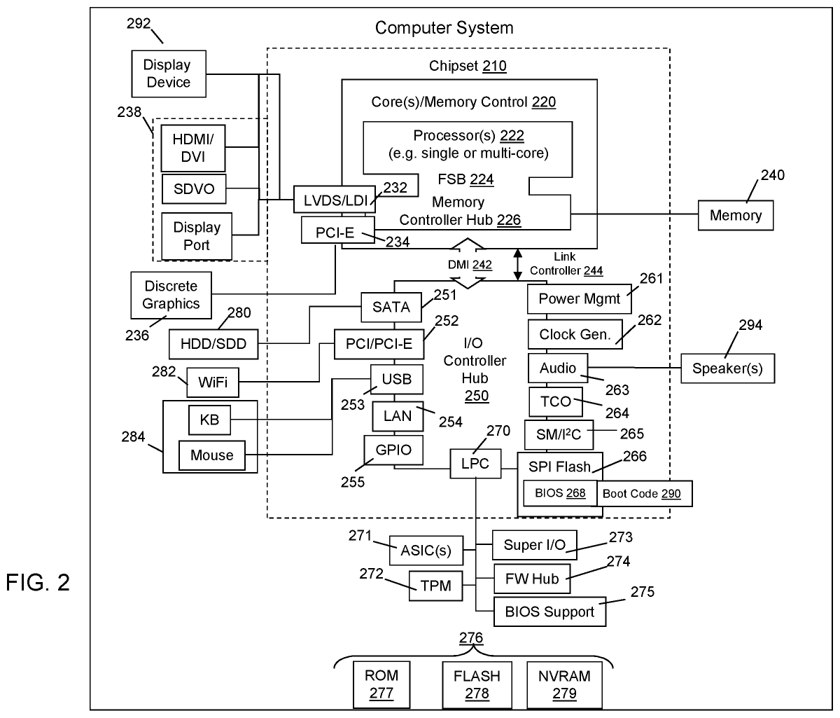

FIG. 2 depicts a block diagram of another example of information handling device circuits, circuitry or components. The example depicted in FIG. 2 may correspond to computing systems such as the THINKPAD series of personal computers sold by Lenovo (US) Inc. of Morrisville, N.C., or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer (for example, INTEL, AMD, ARM, etc.). INTEL is a registered trademark of Intel Corporation in the United States and other countries. AMD is a registered trademark of Advanced Micro Devices, Inc. in the United States and other countries. ARM is an unregistered trademark of ARM Holdings plc in the United States and other countries. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of RAM that may be referred to as “system memory” or “memory”). The memory controller hub 226 further includes a low voltage differential signaling (LVDS) interface 232 for a display device 292 (for example, a CRT, a flat panel, touch screen, etc.). A block 238 includes some technologies that may be supported via the LVDS interface 232 (for example, serial digital video, HDMI/DVI, display port). The memory controller hub 226 also includes a PCI-express interface (PCI-E) 234 that may support discrete graphics 236.

In FIG. 2, the I/O hub controller 250 includes a SATA interface 251 (for example, for HDDs, SDDs, etc., 280), a PCI-E interface 252 (for example, for wireless connections 282), a USB interface 253 (for example, for devices 284 such as a digitizer, keyboard, mice, cameras, phones, microphones, storage, other connected devices, etc.), a network interface 254 (for example, LAN), a GPIO interface 255, a LPC interface 270 (for ASICs 271, a TPM 272, a super I/O 273, a firmware hub 274, BIOS support 275 as well as various types of memory 276 such as ROM 277, Flash 278, and NVRAM 279), a power management interface 261, a clock generator interface 262, an audio interface 263 (for example, for speakers 294), a TCO interface 264, a system management bus interface 265, and SPI Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be used in devices capable of displaying augmented reality content. For example, the circuitry outlined in FIG. 1 may be implemented in a smart phone or tablet embodiment, whereas the circuitry outlined in FIG. 2 may be implemented in a laptop computer.

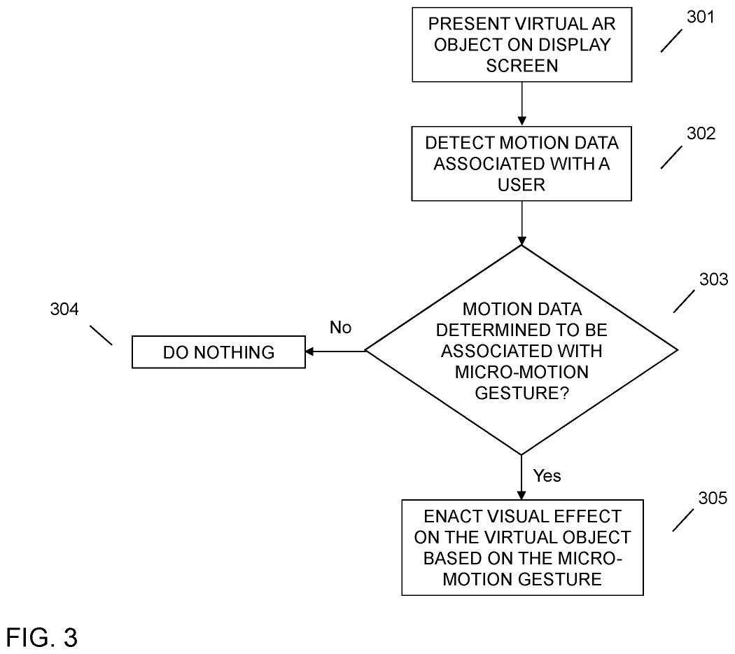

Referring now to FIG. 3, a method for enacting a visual effect on a virtual object using a natural and intuitive user gesture. At 301, an embodiment may display a virtual object on a display of a device. In the context of this application, a virtual object may correspond to virtually any type of visual AR object positioned at some point in space. In an embodiment, the device may be virtually any device capable of displaying AR content. For simplicity purposes, the device described throughout the remainder of this application is an AR headset that may be worn by a user.

At 302, an embodiment may utilize one or more sensors to detect user motion data. In the context of this application, user motion data may refer to virtually any type of conventional physical movement (e.g., head movement, eye movement, hand movement, etc.) that may be detected by one or more sensors (e.g., a camera or video sensor, another type of motion sensor, etc.). In an embodiment, the sensor may be integrated into the device or, alternatively, may be separate from, but still in communication with, the device (e.g., via a wired or wireless connection, etc.). In an embodiment, the sensor may dynamically activate in response to a predetermined event (e.g., when the device is turned on, when an AR application is opened, when a virtual object is detected on the screen, etc.). Once activated, the sensor may continue to monitor for user motion data until an indication is received to deactivate (e.g., the device is turned off, an AR application is closed, a virtual object is no longer detected on the screen, etc.).

At 303, an embodiment may determine whether the detected user motion corresponds to a micro-motion gesture. In the context of this application, a micro-motion gesture corresponds to a subtle body movement that may mimic a real-world action performed by a user and that may also provide an indication to the device to perform a task. For example, a user attempting to obtain better clarity about a real-world object (e.g., an object that is positioned far away from the user, an object containing small text, images, or other visual details, etc.) may lean forward and/or squint their eyes when looking at the object.

In an embodiment, the micro-motion gesture may correspond to a single user movement (e.g., a head tilting forward or backward, a user's gaze settling on a virtual object for a predetermined period of time, etc.). Alternatively, the micro-motion gesture may be composed of two or more user movements, henceforth referred to as “sub-gestures”. When performed in a predetermined sequence, an embodiment may identify this combination of sub-gestures as an intention by the user to provide a micro-motion gesture. For example, the combination of a user squinting and subsequently tilting their head forward may be identified as a single micro-motion gesture to magnify an object.

In an embodiment, these sub-gestures do not both necessarily need to be physical user movements. More particularly, sensors exist (e.g., electroencephalography (EEG) sensors, etc.) that can monitor and detect periodic signals of brain activity. Research has shown that users can control these signals with their thoughts. Accordingly, if an EEG or other like sensor is available (e.g., where the sensor is integrated into or in communication with the device, etc.) then a detected brain signal indicating a user's intention to provide a command may be considered a sub-gesture. This “mental” sub-gesture may be utilized in combination with a physical sub-gesture (e.g., a squint action, a head tilt movement, etc.) to form a micro-motion gesture.

To facilitate the determination process described above, an embodiment may access a data store (e.g., stored locally on the device or remotely on another device or server, etc.) containing a list of predetermined user movements, or predetermined movement sequences, that may be associated with sub-gestures or micro-motion gestures. The listing of associations may be originally provided by a programmer or manufacturer and may later be manually updated by a user. Additionally or alternatively, this listing may be dynamically updated over time using, for example, crowdsourced data.

Responsive to determining, at 303, that the detected motion data does not correspond to a micro-motion gesture, an embodiment may, at 304, take no additional action. Conversely, responsive to determining, at 303, that the detected motion data does correspond to a micro-motion gesture, an embodiment may, at 305, enact a visual effect on the display related to the virtual object. Although a variety of visual effects may be performed, for illustrative purposes the remainder of this application will focus on magnification, reduction, and re-positioning actions. It is important to note that this is not limiting and that other types of visual effects, not explicitly described here, may also be performed.

In an embodiment, in response to detection of a micro-motion gesture associated with content magnification (e.g., detection of a squinting action, a forward head tilt action, a squint and forward head tilt combination, a brain signal and squint or forward head tilt combination, etc.) an embodiment may magnify, or zoom in on, a particular virtual object. For example, if a plurality of AR application windows are displayed, a user may want to better examine the content contained within one of the application windows. In such a situation, they may perform a magnification micro-motion gesture that prompts the system to magnify the desired application window. In order to reduce, or zoom out from, the virtual object, a user may provide a micro-motion gesture associated with content reduction (e.g., a user may perform a backward head tilt action, a squint action combined with a backward head tilt action, etc.).

In an embodiment, identification of the portion of the screen that the user wants magnified may be facilitated in one or more ways. For example, an embodiment may identify a position on the display screen corresponding to a location of user gaze. If an embodiment identifies that the gaze location corresponds to a virtual object, an embodiment may magnify the virtual object when a micro-motion gesture to magnify is identified. In another embodiment, if a plurality of different types of virtual objects are identified, a user may audibly designate the virtual object they want magnified. For example, a tree, a ball, and a building may be presented on a user's AR display. An embodiment may magnify the ball responsive to detecting (e.g., using a microphone associated with the device, etc.) the user's audible input (e.g., “ball”, “the ball”, etc.) coupled with an identified micro-motion gesture to magnify.

In an embodiment, detection of a single magnification micro-motion gesture may magnify a virtual object by a predetermined amount (e.g., 2× magnification, etc.). The predetermined amount my originally be set by a manufacturer or programmer and may later be adjusted by a user. In an embodiment, successively provided similar micro-motion gestures may amplify a visual effect on the virtual object. For example, if a virtual object is already magnified and a magnification micro-motion gesture is detected again, the second magnification may be a 4× magnification, the third an 8× magnification, and so on.

In an embodiment, as part of the content magnification, an embodiment may automatically center the magnified virtual object on the user's display. Alternatively, if the magnified content is not automatically centered, a user may provide positional, micro-gesture adjustments to the magnified virtual object in order to position it at whatever point on their display that they like. For example, a system may be configured to identify user eye movements as controlling gestures for magnified content repositioning. In such a situation, the user can move the virtual object up, down, left, and right by simply moving their eyes.

The various embodiments described herein thus represent a technical improvement to conventional methods for enacting a visual effect on a virtual object. Using the techniques described herein, an embodiment may first present an AR virtual object on a display screen of a device. An embodiment may then detect user motion data and thereafter determine whether the user motion data corresponds to normal user movement or to a micro-motion gesture. Responsive to determining that the user motion data corresponds to the latter, an embodiment may enact a visual effect on the virtual object. For example, an embodiment may zoom in on the virtual object, zoom out from the virtual object, center the virtual object on the user's display, and the like. Such a method may allow a user to better visualize AR content by utilizing gestures that are more natural and indicative of how they would perceive content in the real-world.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, a system, apparatus, or device (e.g., an electronic, magnetic, optical, electromagnetic, infrared, or semiconductor system, apparatus, or device) or any suitable combination of the foregoing. More specific examples of a storage device/medium include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and “non-transitory” includes all media except signal media.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

1. A method, comprising:
displaying, on a display screen of an augmented reality device, a virtual object;
detecting, using at least one sensor associated with the augmented reality device, motion data of at least one micro-motion comprising a sub-gesture of an eye squint and another sub-gesture of a head motion from a user;
determining, using a processor, whether the motion data corresponds to a micro-motion gesture of an intended command of the user; and
enacting, responsive to determining that the motion data corresponds to the micro-motion gesture, a visual effect on the virtual object, wherein the visual effect zooms in upon the virtual object a predetermined amount based upon the detected sub-gesture.

2. The method of claim 1, wherein the augmented reality device is an augmented reality headset.

3. The method of claim 1, wherein the micro-motion gesture is composed of two sub-gestures performed by the user in succession.

4. The method of claim 1, wherein the enacting the visual effect comprises reducing the virtual object on the display screen.

5. The method of claim 1, wherein the enacting the visual effect comprises magnifying the virtual object on the display screen.

6. The method of claim 5, wherein the magnifying comprises:
identifying that a gaze location of the user is associated with a portion of the virtual object; and
repositioning the portion of the virtual object to a center of the display screen.

7. The method of claim 5, wherein the magnifying comprises increasing a magnification on the virtual object by a predetermined amount in response to each additional micro-motion gesture.

8. The method of claim 5, further comprising:
detecting, during a magnified view of the virtual object, a position adjustment micro-gesture; and
adjusting a center position of the virtual object based on the position adjustment micro-gesture.

9. The method of claim 1, wherein the at least one sensor comprises an electroencephalography (EEG) sensor.

10. The method of claim 9, wherein the determining comprises:
detecting, using the EEG sensor, a brain signal;
determining, using a processor, whether the brain signal indicates an intent for the user motion data to be interpreted as the micro-motion gesture; and
classifying the user motion data as the micro-motion gesture responsive to identifying that the brain signal contains the intent.

11. An information handling device, comprising:
a sensor;
a display screen;
a processor;
a memory device that stores instructions executable by the processor to:
display a virtual object;
detect motion data of at least one micro-motion comprising a sub-gesture of an eye squint and another sub-gesture of a head motion from a user;
determine whether the motion data corresponds to a micro-motion gesture of an intended command of the user; and
enact, responsive to determining that the motion data corresponds to the micro-motion gesture, a visual effect on the virtual object, wherein the visual effect zooms in upon the virtual object a predetermined amount based upon the detected sub-gesture;

12. The information handling device of claim 11, wherein the information handling device is an augmented reality headset.

13. The information handling device of claim 11, wherein the micro-motion gesture is composed of two sub-gestures performed the user in succession.

14. The information handling device of claim 11, wherein the instructions executable by the processor to enact the visual effect comprise instructions executable by the processor to reduce the virtual object on the display screen.

15. The information handling device of claim 11, wherein the instructions executable by the processor to enact the visual effect comprise instructions executable by the processor to magnify the virtual object on the display screen.

16. The information handling device of claim 15, wherein the instructions executable by the processor to magnify comprise instructions executable by the processor to:
identify that a gaze location of the user is associated with a portion of the virtual object; and
reposition the position of the virtual object to a center of the display screen.

17. The information handling device of claim 15, wherein the instructions executable by the processor to magnify comprise instructions executable by the processor to increase a magnification on the virtual object by a predetermined amount in response to each additional micro-motion gesture.

18. The information handling device of claim 15, wherein the instructions are further executable by the processor to:
detect, during a magnified view of the virtual object, a position adjust micro-gesture; and
adjust a center position of the virtual object based on the position adjustment micro-gesture.

19. The information handling device of claim 11, wherein the at least one sensor is an electroencephalography (EEG) sensor and wherein the instructions executable by the processor to determine comprise instructions executable by the processor to:
detect a brain signal;
determine whether the brain signal indicates an intent for the user motion data to be interpreted as the micro-motion gesture; and
classify the user motion data as the micro-motion gesture responsive to identifying that the brain signal contains the intent.

20. A product, comprising:
a non-transitory storage device that stores code, the code being executable by a processor and comprising:
code that displays a virtual object;
code that detects motion data of at least one micro-motion comprising a sub-gesture of an eye squint and another sub-gesture of a head motion from a user;
code that determines whether the motion data corresponds to a micro-motion gesture of an intended command of the user; and
code that enacts, responsive to determining that the motion data corresponds to the micro-motion gesture, a visual effect on the virtual object, wherein the visual effect zooms in upon the virtual object a predetermined amount based upon the detected sub-gesture.
